(19) United States
(12) Patent Application Publication
(10) Pub. No.: US 2007/0213957 A1
(43) Pub. Date: Sep. 13, 2007

(54) Method and system for clustering objects and finding prime redescriptors for the clusters

(75) Inventor: Laxmi P. Parida, Mohegan Lake, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: International Business Machines Corporation, Armonk, NY (US)

(21) Appl. No.: 11/346,845

(22) Filed: Feb. 3, 2006

(51) Int. Cl. G06F 19/00

(52) U.S. Cl. 702/189; 702/22; 702/27

(57) ABSTRACT

Disclosed are a method of and system for clustering objects and finding prime redescriptors for the clusters of objects. The method comprises the step of forming a matrix, including (i) identifying on the matrix, each of a set of given objects, and (ii) for each of said set of objects, identifying on the matrix, by using binary values, whether or not the object has each of a set of given features. The method comprises the further steps of finding all the minimal pure disjunctions on the matrix, adding said minimal pure disjunctions to the matrix to form an augmented matrix, and finding all the maximal pure conjunctions on the augmented matrix. These maximal pure conjunctions are used to identify prime redescriptors for the set of objects.

### BACKGROUND OF THE INVENTION

1. Field of the Invention

This invention generally relates to methods and systems for clustering objects and finding prime redescriptors for the clusters.

2. Background Art

In many technologies, enormous amounts of information are available. For example, in biogenetics, huge amounts of data can be collected. It is often useful to group data objects together in categories or clusters. There are many ways to do this. Unfortunately, with many current systems, important information can be lost when the data objects are grouped.

For example, given a body of evidence, such as, a list of n patients and the expression level of m genes and no further evidence, what can be said about the patients? The data is usually given as an n×m array D. One natural task is to find all the groups of size≧k and deduce their description. Then the next question is to get all the redescriptions or other alternate ways of defining this group based on the evidence D. For example, a group may be denoted by patients who have genes 1, 2 and 3 expressed at a high level. It is possible that the same group is denoted by high level of expression of gene 1 along with the expression of either genes 4; or 5. These different expressions denote the same group and is an important information to have for a better understanding of the data. It would be desirable to organize and access the data so that important information like this is not lost.

### SUMMARY OF THE INVENTION

An object of this invention is to cluster objects and to find prime redescriptors for the clusters.

Another object of the present invention is to provide a method and system for identifying, for defined data sets, the smallest collection of all the essential descriptions that can define every other description in the data set.

These and other objects are attained with a method of and system for clustering objects and finding prime redescriptors for the clusters of objects. The method comprises the step of forming a matrix, including (i) identifying on the matrix, each of a set of given objects, and (ii) for each of said set of objects, identifying on the matrix, by using binary values, whether or not the object has each of a set of given features. The method comprises the further steps of finding all the minimal pure disjunctions on the matrix, adding said minimal pure disjunctions to the matrix to form an augmented matrix, and finding all the maximal pure conjunctions on the augmented matrix. These maximal pure conjunctions are used to identify prime redescriptors for the set of objects.

The preferred embodiment of the invention, described below in detail, utilizes a principal, referred to as prime descriptors, which is the smallest collection of all the essential descriptions that can define every other description in the data set.

Redescriptions, in a setting where the expressions are disjunctions of conjunctions of two (or less) variables, is discussed in “Turning cartwheels: An alternating algorithm for mining redescriptions” In ACM SIGKDD Conference on Knowledge Discovery and Data Mining. ACM Press, August 2004. by N. Ramakrishnan, D. Kumar, B. Mishra, M. Potts, and R. F. Helm (Ramakrishnan, et al.).

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 shows a preferred method for practicing the invention.

FIG. 2 shows a part of a graph that illustrates an aspect of this invention.

### DETAILED DESCRIPTION OF THE PREFERRED EMBODIMENTS

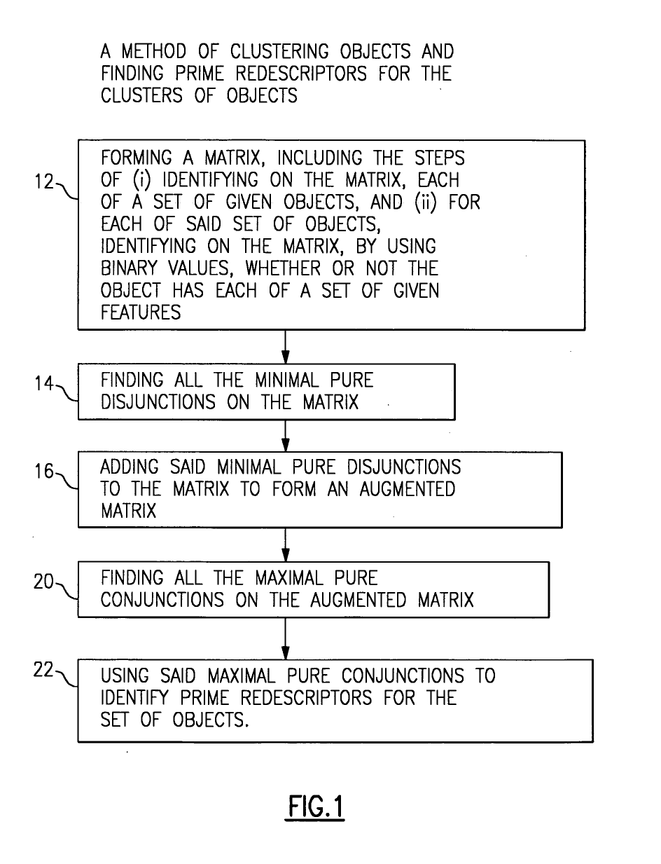

The present invention, generally, provides a method and system for clustering objects and finding prime redescriptors for the clusters. FIG. 1 illustrates a preferred method for carrying out the invention. The method comprises the step 12 of forming a matrix, including (i) identifying on the matrix, each of a set of given objects, and (ii) for each of said set of objects, identifying on the matrix, by using binary values, whether or not the object has each of a set of given features.

The method comprises the further step 14 of finding all the minimal pure disjunctions on the matrix, step 16 of adding said minimal pure disjunctions to the matrix to form an augmented matrix, and step 20 of finding all the maximal pure conjunctions on the augmented matrix. These maximal pure conjunctions are used at step 22 to identify prime redescriptors for the set of objects.

The following examples and definitions will illustrate the preferred embodiment of the invention.

Input: Given o₁, o₂, . . . , oₙ objects, each with or without F₁, F₂, . . . Fₘ features represented in a binary matrix D where D[i],[J]=0 if feature Fⱼ is absent in object oᵢ and D[i]L=1 otherwise. Consider the following example from Ramakrishnan, et al:

| | X₁ | X₂ | X₃ | X₄ | Y₁ | Y₂ | Y₃ | Y₄ |
|---|---|---|---|---|---|---|---|---|
| o₁ | 0 | 0 | 0 | 1 | 1 | 0 | 0 | 1 |
| o₂ | 1 | 0 | 1 | 0 | 1 | 1 | 0 | 1 |
| o₃ | 1 | 1 | 0 | 0 | 0 | 1 | 1 | 0 |
| o₄ | 0 | 1 | 1 | 0 | 0 | 1 | 0 | 0 |
| o₅ | 0 | 0 | 0 | 1 | 0 | 0 | 1 | 1 |

Definition 1 (description e, F(e), S(e), redescription R(e)) Given D,
1. e(V) or e, a boolean expression on the set of variables (features) V is a description. F(e) denotes the set of features used in the description, i.e., F(e)=V. Further,
   S(e)={oᵢ|e is TRUE for D [oᵢ]}

Two descriptions are e₁(V₁) and e₂(V₂) are distinct (denoted as e₁≠e₂), if one of the following holds: (1) V₁≠V₂, or (2) there exists some D′ for which S(e₁)≠S(e₂). This rules out tautologies. For example, expressions (X₁−X₂) and (X₁ X̅₂ ) are not distinct.

2. e′ is a redescription of e, if and only if S(e) =S(e′) holds for the given D. R(e) a collection of all distinct redescriptions of e.

Consider D shown in the example. S (e=(X₁+Y₃))=(o₂, o₃, o₅} and S(e=( X̅₁ Y̅₃))=(o₁, o₄} are descriptions (on D). The following property about redescriptions is important: it enables us to divide the description space into non-overlapping sets.

Lemma 1 Redescription is reflexive, symmetric and transitive: it induces a partition on a collection of descriptions on D.

Fact 1 Given D, if (e₂≠e₁) ε 2 R(e), then (e₁e₂), (e₁+e₂) ε R(e).

Clearly there are some redundancies in R(e). The next task is to trim down R(e) to its essentials! Next we discuss the acceptable forms an expression may take.

An important question to address is whether fixing a set of variables (features) on a collection of elements (or rows) in D, can endow a unique (upto tautology) description. We answer in the negative using a simple example.

| | X₁ | X₂ | X₃ |
|---|---|---|---|
| o₁ | 1 | 0 | 0 |
| o₂ | 0 | 1 | 1 |
| o₃ | 0 | 0 | 1 |
| o₄ | 0 | 0 | 1 |

Let e be a description on X₁ and X₂ and S(e)=(o₁, o₂}. Then given this D, there are at least two distinct descriptions (e₁≠e₂) of e: (1) e₁=X₁+X₂, and, (2) e₂=X₁ X̅₂+ X̅₁ X₂.

Philosophically, description (1) is supported by Occam's Razor Priniciple which advocates the “simplest” form. On the other hand description (2) is more resilient, i.e., even if any one of D[i][j], i=3, 4, j=1, 2 is switched to 1, the description of e with the given S is still valid.

Problem 1 Given an n×m array D and a collection of sets S of the row labels, the problem is to find all the R(e) for each S(e) ε S.

Theorem 1 Given an n×m array D and a collection of sets S of the row labels, if every non-empty set of row labels S ε S, then for each S(e) S, |R(e)|=1 i.e., each set has a unique description (hence no redescription).

Definition 2 (basis B(e)) B(e)_R(e) is a basis of Rye) satisfying the following: (1) for each e₀ ε R(e), there is e₁, e₂, . . . eₘ ε B, m≧1, such that f(e₁, e₂, . . . eₘ) ε B(e) where f() is a Boolean function, and, (2) no e₀ ε B(e) can be represented as a Boolean function of any m, e₁, e₂, . . . eₘ ε B (eᵢ≠e₀, 1≦i ≦m).

A different problem where S is not given can be stated as below: this is perhaps the more tractable version of the problem.

Problem 2 Given an n×m array D, a quorum k, and a specific form of Boolean expression, the problem is to find all the |S(e)|≧k and R(e) where e and each e′ ε R(e) is in the specified form.

Form of Expression. Since expressions involve the features and are a description of a collection of elements, simplicity in their form is desired.

An expression is a pure conjunction if it is a conjunction of atomic elements and a pure disjunction if it is a disjunction of atomic elements. For example, let e₁=(X₁+X₂), e₂=(X₁X₃X₄) and e₃=(X₁+X₂X₃). Then e₁ is a pure disjunction, e₂ is a pure conjunction and e₃ is neither. If e is a pure conjunction then e̅ is a pure disjunction and vice-versa.

Clearly, there are myriads of forms a description can take. Eventually a human-expert will read and interpret the expression. So we have to compromise between expressibility and readability. We choose to use the following form: conjunctions of pure disjunctions (CPD). This form has a powerful expressive capability and yet is understandable in English terms.

Definition 3 (relaxation of e X(e)) Given D and quorum k, let e₁ be an expression on the set of variables V₁=F(e₁), then e₂ is a relaxation of e₁ with V₂=F(e₂), if both of the following hold: (a) V₂ ⊂ V₁ and (b) e₂ is obtained from e₁ by replacing each variable υ ε V₁−V₂ by the constant TRUE. The collection of all the relaxations of e is denoted by X(e).

Lemma 2 If e₂ is a relaxation of e₁ then S(e₂) ⊃ S(e₁).

Note that a relaxation of e is not necessarily a redescription of e. Consider the example in Section 2. X̅₁ ε X ( X̅₁ Y̅₃ ) but X̅₁ ∉ R( X̅₁ Y̅₃ ) since (S( X̅₁)={o₁, o₄, o₅}) ⊃ (S( X̅₁ Y̅₃)={o₁, o₄}).

Definition 4 (prime descriptors P(e)) Given D, and quorum k, P(e) ⊂ R(e) is a set of prime descriptors if (1) for each e′ ε P(e), there is no e′₁, e′₂, . . . , e′ₘ ⊂ P(e)−{e} such that (e′₁, e′₂ . . . e′ₘ) ε P(e). (2) for each e′ ε R(e) there exists e′₁, e′₂, . . . , e′ₘ ⊂ P(e) such that (e′₁, e′₂, . . . , e′ₘ)ε R(e).

Theorem 2 P(e) is unique.

Corollary 1 Any redescription of e is derivable from P(e).

Corollary 2 If |P(e)|>1, then each e′ ε P(e) is a relaxation of some e″ ε R(e).

Algorithm

Input: Given an n×m Boolean matrix D and a quorum k≦n. D represents n elements each with at most m features.

Output: The task is to obtain all descriptions e in the CPD form with P(e), such that |S(e)|≦k.

(1) Preprocess: Find all the minimal pure disjunctions. Let them be A in number. Then this step takes O(mn+A log A) time based on the algorithm in “Protein folding trajectory analysis using patterned clusters” Asia Pacific Bioinformatics Conference, 2005 by J. Feng, L. Parida, and R. Zhou (J. Feng, et al.)

(2) CPD Expressions Computation: Augment the input matrix D with the results of the first step to obtain n×(m+a) matrix D′. Find all the maximal pure conjunctions on this augmented matrix. Let them be B in number. This takes O(m(n+A)+B log B) based on the algorithm in the above-mentioned J. Feng, et al.

(3) Prime Redescription Computation: Consider a directed graph G(V,E) called the universal graph, where υ ε V corresponds to a non-empty subset of the column labels of D′ denoted by C(υ). A directed edge (υ₂ υ₁) ε E if C(υ₁) ⊂ C(υ₂) and |C(υ₂)|−|C(υ₁)|=1. Next, we label each node as follows: if C(υ) is reported in Step 2, we assign the label LIVE, else we assign the label DEAD to vertex υ. Redescription of e:

Let S(e)=C(υ). Then e′ is a redescription of e if υ′ with C(υ′)=S(e′) is a LIVE descendent of υ that has no LIVE ancestor υ″ which is a descendent of υ.

Back to the example. Consider the example presented in Section 2. Assume quorum k=1.

1) Preprocess: At this step we compute the minimal pure disjunctions.

| S(e) | e (minimal pure disjunctions) | new col label |
|---|---|---|
| 2, 3, 4, 5 | X₁ + X₂ + X₃ + X̅₄ + Y̅₁ + Y₂ + Y₃ + Y̅₄ | Z₁ |
| 1, 3, 4, 5 | X̅₁ + X₂ + X̅₃ + X₄ + Y̅₁ + Y̅₂ + Y₃ + Y̅₄ | Z₂ |
| 1, 2, 4, 5 | X̅₁ + X̅₂ + X₃ + X₄ + Y₁ + Y̅₂ + Y̅₃ + Y₄ | Z₃ |
| 1, 2, 3, 5 | X₁ + X̅₂ + X̅₃ + X₄ + Y₁ + Y̅₂ + Y₃ + Y₄ | Z₄ |
| 1, 2, 3, 4 | X₁ + X₂ + X₃ + X̅₄ + Y₁ + Y₂ + Y̅₃ + Y̅₄ | Z₅ |
| 3, 4, 5 | X₂ + Y̅₁ + Y₃ | Z₆ |
| 2, 3, 5 | X₁ + Y₃ | Z₇ |
| 1, 3, 5 | X̅₃ + X₄ + Y̅₂ + Y₃ | Z₈ |
| 1, 2, 3 | X₁ + Y₁ | Z₉ |

2) CPD computation (e's): The expressions in the CPD form are shown below:

| S(e) | e (in CPD form) | S(e) | e (in CPD form) |
|---|---|---|---|
| 1 | X̅₁ X̅₂ X̅₃X₄Y₁ Y̅₂ Y̅₃Y₄ | 2, 3, 4, 5 | Z₁ = (X₁ + X₂ + X₃ + X̅₄ + Y̅₁ + Y₂ + Y₃ + Y̅₄) |
| 2 | X₁ X̅₂X₃ X̅₄Y₁Y₂ Y̅₃Y₄ | 1, 3, 4, 5 | Z₂ = ( X̅₁ + X₂ + X̅₃ + X₄ + Y̅₁ + Y̅₂ + Y₃ + Y̅₄) |
| 3 | X₁X₂ X̅₃ X̅₄ Y̅₁Y₂Y₃ Y̅₄ | 1, 2, 4, 5 | Z₃ = ( X̅₁ + X̅₂ + X₃ + X₄ + Y₁ + Y̅₂ + Y̅₃ + Y₄) |
| 4 | X̅₁X₂X₃ X̅₄ Y̅₁Y₂ Y̅₃ Y̅₄ | 1, 2, 3, 5 | Z₄ = (X₁ + X̅₂ + X̅₃ + X₄ + Y₁ + Y̅₂ + Y₃ + Y₄) |
| 5 | X̅₁ X̅₂ X̅₃X₄ Y̅₁ Y̅₂Y₃Y₄ | 1, 2, 3, 4 | Z₅ = (X₁ + X₂ + X₃ + X̅₄ + Y₁ + Y₂ + Y̅₃ + Y̅₄) |
| 1, 2 | X̅₂Y₁ Y̅₃ | 3, 4, 5 | Z₆ = (X₂ + Y̅₁ + Y₃) |
| 1, 4 | X̅₁ Y̅₃ | 2, 3, 5 | Z₇ = (X₁ + Y₃) |
| 1, 5 | X̅₁ X̅₂ X̅₃X₄ Y̅₂Y₄ | 2, 3, 4 | X̅₄Y₂ |
| 2, 3 | X₁ X̅₄Y₂ | 1, 4, 5 | X̅₁ |
| 2, 4 | X₃ X̅₄Y₂ Y̅₃ | 1, 3, 5 | Z₈ = ( X̅₃ + X₄ + Y̅₂ + Y₃) |
| 3, 4 | X₂ X̅₄ Y̅₁Y₂ Y̅₄ | 1, 2, 5 | X̅₂Y₄ |
| 3, 5 | X̅₃ Y̅₁Y₃ | 1, 2, 4 | Y̅₃ |
| 4, 5 | X̅₁ Y̅₁ | 1, 2, 3 | Z₉ = (X₁ + Y₁) |

3) Computing Prime Redescriptions (P(e)'s). We take two cases that were also handled in Ramakrishnan, et al. Here we complete the answers using prime descriptors. In the example the features were partitioned into two sets the Xⱼ's and the Yⱼ's such that each redescription is from only one set or the other. As an example consider the set S(e₁)={o₄}. The prime descriptors that separate the X's from the Y's are:
e₁ [symbol] X̅₁X₂ [symbol] X̅₁ X̅₄ [symbol] X₂X₃ [symbol] Y̅₁ Y̅₃ [symbol] Y̅₃̅ Y̅₄

If the mixing of the X's and the Y's are allowed,
e₁ [symbol] X̅₁Y₂ [symbol] X̅₁ Y̅₄ [symbol] X₂ Y̅₃ [symbol] X₃ Y̅₁ [symbol] X₃ Y̅₄ [symbol] X̅₄Y₃

The only redescriptions shown in N. Ramakrishnan, et al are:
e₁ [symbol] X̅₁X₃ [symbol] Y̅₁ Y̅₃ [symbol] Y̅₃ Y̅₄

The following are some non-prime descriptors. Note that each can be derived or deduced trivially from the prime descriptors.
e₁ [symbol] X̅₁X₂X₃ [symbol] X̅₁X₂ X̅₄ [symbol] X̅₁X₃ X̅₄ [symbol] X̅₁X₂X₃ X̅₄ [symbol] Y̅₁Y₂ Y̅₃ [symbol] Y₂ Y̅₃ Y̅₄ [symbol] Y̅₁Y₂ Y̅₃ Y̅₄

Consider a second example S(e₂)={o₁, o₂, o₅}. The prime descriptors of this are:
e₂ [symbol] X̅₂ [symbol] Y₄

Ramakrishnan, et al. gives the redescriptions as:
e₂ [symbol] (X₃∩X₁)∪(X₄−X₃) [symbol] (Y₃−Y₂)∪(Y₁−Y₃) [symbol] Y₄

2.2 On Jaccard's coefficient J<1
Given two sets S₁ and S₂ the Jaccard's coefficient Jof the two is given by

$$J ( {S}_{1} , {S}_{2} ) = \frac{\vert {S}_{1} ⋂ {S}_{2} \vert}{\vert {S}_{1} ⋂ {S}_{2} \vert + \vert {S}_{1} - {S}_{2} \vert + \vert {S}_{2} - {S}_{1} \vert}$$

When S₁ and S₂ are identical, then J=1.0. In practice, it is useful to talk about sets that are nearly equal but not necessarily exactly, i.e., the two sets have a Jaccard's coefficient<1.

In this problem setting, we absorb this “approximation” in Steps 1 and 2, so that the prime descriptor computation step is unchanged. Next, we redefine S(e) taking Jaccard's coefficient J into account as follows:

Definition 5 (S(e)) Given D, a quorum k and a Jaccard's coefficient 0<ξ<1. Let eᵢ be the expression e restricted to the feature υᵢ i.e., (F(eᵢ)={υᵢ})⊂F(e), and let S(eᵢ)⊂S(e) be the collection of rows where eᵢ holds. Then for each pair υᵢ, υⱼ ε F(e), the following must hold:
J(S(eᵢ), S(eⱼ)=ξ

Thus the burden of the computation is isolated into the first two steps of the algorithm. The two steps can use the algorithm presented in “Approximate patterns on mulit-feature data.” 2004. Manuscript. L. Parida (Parida).

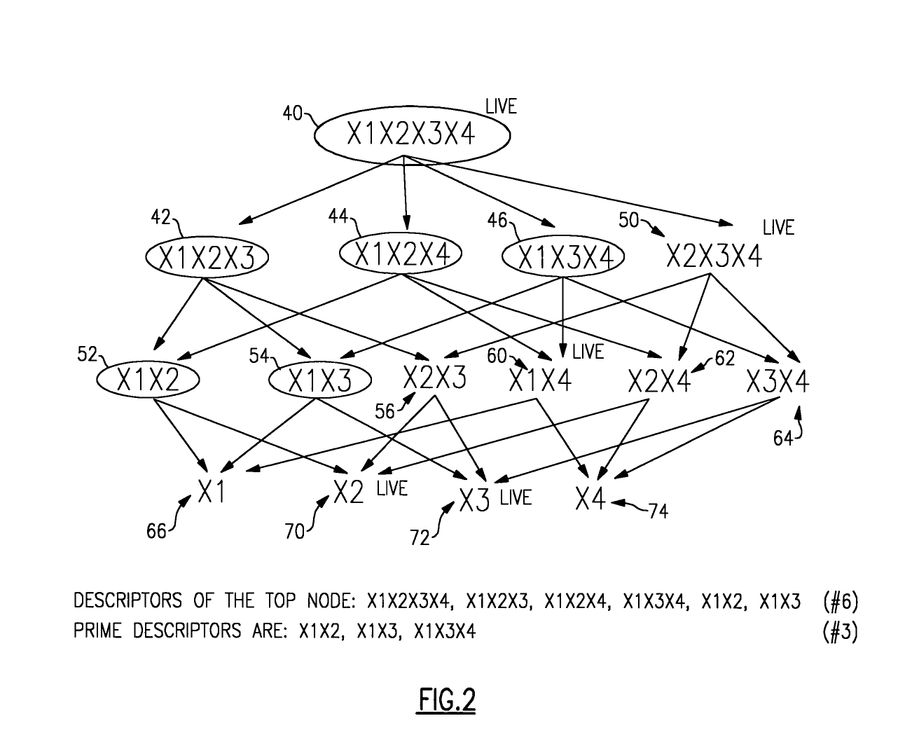

FIG. 2 illustrates an example of the application of the instant invention. This example starts with a cluster 40 of four objects X1X2X3X4. This cluster 40 can be re-expressed as four separate clusters 42, 44, 46 and 50, each of which has three of the four objects of cluster 40. These four clusters, in turn, can be re-expressed as six clusters 52, 54, 56, 60, 62 and 64, each of which has two of the objects of the original cluster 40. Each of the clusters 42, 44, 46, and 50 can be re-expressed as three separate clusters, however because of commonality, a total of six clusters are re-expressed from the four clusters 42, 44, 46 and 50. The clusters 52, 54, 56, 60, 62 and 64 can be re-expressed as a total of four clusters 66, 70, 72 and 74, each of which has a respective one of the objects of the original cluster 40. As FIG. 2 shows, the prime descriptors are X1X2, X1X3 and X1X3X4.

It should be understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized.

The present invention can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art and it is intended that the appended claims cover all such modifications and embodiments as fall within the true spirit and scope of the present invention.

What is claimed is:

1. A method of clustering objects and finding prime redescriptors for the clusters of objects, the method comprising the steps of:
forming a matrix, including the steps of
i) identifying on the matrix, each of a set of given objects, and
ii) for each of said set of objects, identifying on the matrix, by using binary values, whether or not the object has each of a set of given features;
finding all the minimal pure disjunctions on the matrix;
adding said minimal pure disjunctions to the matrix to form an augmented matrix;
finding all the maximal pure conjunctions on the augmented matrix; and
using said maximal pure conjunctions to identify prime redescriptors for the set of objects.

2. A method according to claim 1, wherein the using step includes the step of separating said set of features into two subsets such that each redescription is from only one or only the other of said two subsets.

3. A method according to claim 1, wherein the using step includes the steps of:
using a directed graph having a multitude of vertices to represent said maximal pure conjunctions; and
identifying selected ones of said vertices as representing the prime redescriptors.

4. A method according to claim 1, wherein a pure disjunction is a disjunction of atomic elements, and a pure conjunction is a conjunction of atomic elements.

5. A method according to claim 1, wherein said maximal pure conjunctions are pure conjunctions of pure disjunctions.

6. A method according to claim 1, wherein the step of finding all the minimal pure disjunctions includes the step of eliminating duplicate pure disjunctions to obtain said minimal pure disjunctions.

7. A method according to claim 1, wherein the step of adding said minimal pure disjunctions to the matrix includes the step of representing said minimal pure disjunctions as additional features on the matrix.

8. A system for clustering objects and finding prime redescriptors for the clusters of objects, the system comprising:
means defining a matrix, the matrix (i) identifying each of a set of given objects; and (ii) for each of said set of objects, identifying, by use of binary values, whether or not the object has each of a set of given features;
means for finding all the minimal pure disjunctions on the matrix;
means for adding said minimal pure disjunctions to the matrix to form an augmented matrix;
means for finding all the maximal pure conjunctions on the augmented matrix; and
means for using said maximal pure conjunctions to identify prime redescriptors for the set of objects.

9. A system according to claim 8, wherein the means for using includes means for identifying two separate subsets of said set of features such that each redescription is from only one or only the other of said two subsets.

10. A system according to claim 8, wherein the using means includes:
means defining a directed graph having a multitude of vertices to represent said maximal pure conjunctions; and
means for identifying selected ones of said vertices as representing the prime redescriptors.

11. A system according to claim 8, wherein:
a pure disjunction is a disjunction of atomic elements;
a pure conjunction is a conjunction of atomic elements; and
said maximal pure conjunctions are pure conjunctions of pure disjunctions.

12. A system according to claim 8, wherein the means for finding all the minimal pure disjunctions includes means for eliminating duplicate pure disjunctions to obtain said minimal pure disjunctions.

13. A system according to claim 8, wherein the means for adding said minimal pure disjunctions to the matrix includes means for representing said minimal pure disjunctions as additional features on the matrix.

14. A program storage device readable by machine, tangibly embodying a program of instructions executable by the machine to perform method steps for clustering objects and finding prime redescriptors for the clusters of objects, the method steps comprising:
forming a matrix, including the steps of
a. identifying on the matrix, each of a set of given objects, and
b. for each of said set of objects, identifying on the matrix, by using binary values, whether or not the object has each of a set of given features;
finding all the minimal pure disjunctions on the matrix;
adding said minimal pure disjunctions to the matrix to form an augmented matrix;
finding all the maximal pure conjunctions on the augmented matrix; and
using said maximal pure conjunctions to identify prime redescriptors for the set of objects.

15. A program storage device according to claim 14, wherein the using step includes the step of separating said set of features into two subsets such that each redescription is from only one or only the other of said two subsets.

16. A program storage device according to claim 14, wherein the using step includes the steps of:
using a directed graph having a multitude of vertices to represent said maximal pure conjunctions; and
identifying selected ones of said vertices as representing the prime redescriptors.

17. A program storage device according to claim 14, wherein:
a pure disjunction is a disjunction of atomic elements,
a pure conjunction is a conjunction of atomic elements, and
said maximal pure conjunctions are pure conjunctions of pure disjunctions.

18. A method according to claim 14, wherein:
the step of finding all the minimal pure disjunctions includes the step of eliminating duplicate pure disjunctions to obtain said minimal pure disjunctions; and
the step of adding said minimal pure disjunctions to the matrix includes the step of representing said minimal pure disjunctions as additional features on the matrix.
